(19) United States
(12) Patent Application Publication
(10) Pub. No.: US 2009/0055486 A1
(43) Pub. Date: Feb. 26, 2009

(54) INSTANT MESSAGING NETWORK CAMERA

(76) Inventor: Shihn-Cheng CHEN, Yonghe City (TW)

Correspondence Address: PATENTTM.US, P. O. BOX 82788, PORTLAND, OR, 97282-0788, US

(21) Appl. No.: 11/844,236

(22) Filed: Aug. 23, 2007

(51) Int. Cl. G06F 15/16

(52) U.S. Cl. 709/206

(57) ABSTRACT

An instant messaging network camera has a processor, an image sensor, an audio receiver, an input device, a network connecting module and memory. The processor has a video and an audio encoder. The image sensor is electronically connected to the processor and captures images. The network connecting module is used to connect to an instant messaging service server over the Internet and is electronically connected to the processor. The memory is electronically connected to the processor and has an automatic operating process. The automatic operating process is executed by the processor to log on to an instant messaging service, receive viewing requests sent from a client device also logged on to the instant messaging service and send images to the client device. Therefore, a user can set up and control the network camera easily over the instant messaging service for increased security.

### BACKGROUND OF THE INVENTION

1. Field of the Invention

The present invention relates to a camera, and more particularly to a network camera used in conjunction with an instant messaging service.

2. Description of Related Art

Encoding and transmitting real-time audio and video are applied widely to network cameras, video servers, digital video recorders capable of connecting to a network, network video recorders and the like, especially network cameras used to remotely monitor and view images.

Remotely viewing and monitoring images, amongst others, allows users to check on areas for added security. This may include their house during vacation, their office or workplace outside of work hours, a second or holiday home, storage areas, especially for boats, yachts, cars or other specific areas of their home at particular risk, maybe swimming pools and ponds for parents of young children and areas at risk of fire, burglary and the like.

A conventional method for connecting to the network camera from a client computer is to build a web site in the network camera. The web site provides web pages having viewable image functions. Therefore, a user can use the web browser installed in the client computer to connect to the web site over the Internet.

This requires a static or dynamic Internet Protocol (IP) address service. The static IP service is more expensive than the dynamic IP address service.

However, the dynamic IP address may be different each time when the network camera is on-line and this causes difficulty in searching for the network camera using the client computer. A dynamic Domain Name System (DNS) will solve the dynamic IP address problem.

However, many computer users are not capable of setting up a complex system required by prior art so cannot benefit from added security and application of network cameras.

In addition, if the client computer or the conventional network camera is connected to the Internet via a Network Address Translation (NAT) router, the NAT router will block the video and audio data sent from the conventional network camera.

To overcome the shortcomings, the present invention provides a network camera used in conjunction with an instant messaging service to mitigate or obviate the aforementioned problems.

### SUMMARY OF THE INVENTION

The main objective of the invention is to provide a network camera used in conjunction with an instant messaging service.

The network camera in accordance with the present invention comprises a processor, an image sensor, an audio receiver, an input device, a network connecting module and memory. The processor has a video and an audio encoder. The image sensor is electronically connected to the processor and captures images. The network connecting module is used to connect to an instant messaging service server over the Internet and is electronically connected to the processor. The memory is electronically connected to the processor and has an automatic operating process. The automatic operating process is executed by the processor to log on to an instant messaging service, receive viewing requests sent from a client device also logged on to the instant messaging service and send images to the client device. Therefore, a user can set up and control the network camera easily over the instant messaging service for increased security.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an embodiment of an instant messaging network camera in accordance with the present invention;

FIG. 2 is a schematic diagram of the instant messaging network camera and client devices connecting to the instant messaging service server;

FIG. 3 is a logic diagram of an automatic operating process executed by a processor in FIG. 1;

FIG. 4 is a logic diagram of a warning process executed by a processor in FIG. 1; and

FIG. 5 is a logic diagram of a control process executed by a processor in FIG. 1.

### DETAILED DESCRIPTION OF PREFERRED EMBODIMENT

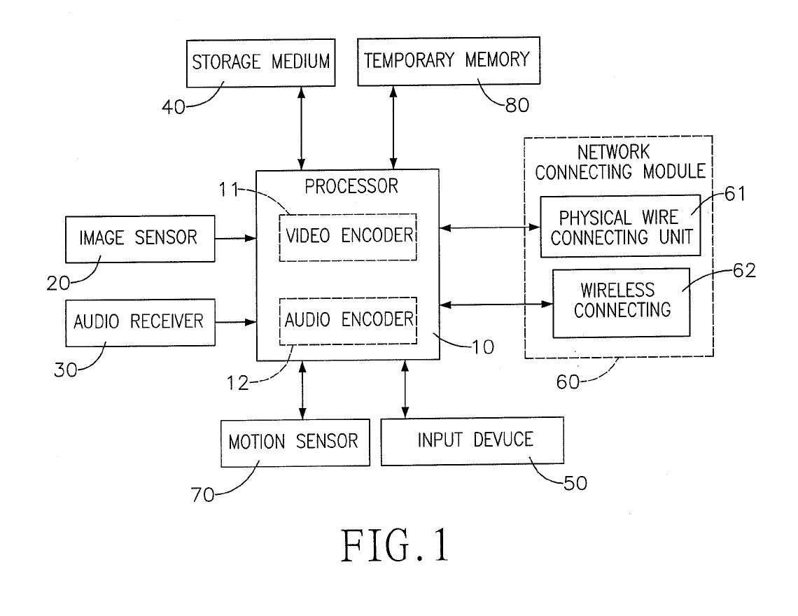

With reference to FIG. 1, an instant messaging network camera in accordance with the present invention is capable of automatically logging on to an instant messaging service, such as the MSN service, Yahoo Messenger service, Skype service or the like. Most instant messaging services are capable of video conferencing. Furthermore, the network camera in accordance with the present invention comprises a processor (10), an image sensor (20), an audio receiver (30), an optional storage medium (40), an input device (50), a network connecting module (60), an optional motion sensor (70) and memory (80).

The processor (10) has a video encoder (11) and an audio encoder (12).

The image sensor (20) is electronically connected to the processor (10), captures images and converts captured images into digital image data to allow the video encoder (11) in the processor (10) to encode the digital image data.

The audio receiver (30) comprises a microphone (31) and an analog to digital (A/D) unit (32). The microphone (31) converts sounds into analog signals. The A/D unit (32) is electronically connected between the processor (10) and the microphone (31) to convert the analog signals into digital sound data to allow the audio encoder (12) in the processor (10) to encode the digital sound data.

The storage medium (40) is electronically connected to the processor (10) to store the encoded digital image and sound data.

The input device (50) is electronically connected to the processor (10) and allows to perform an initial setup to input a registered instant messaging user account and a password of the network camera and a registered instant messaging user account of a client device for logging on to the instant messaging service. Furthermore, the input device (50) may be an input and output connector such as a universal serial bus connector that allows a computer to connect to the input device (50) to perform the initial setup. The client device may be a computer, a cell phone, a personal digital assistant or the like.

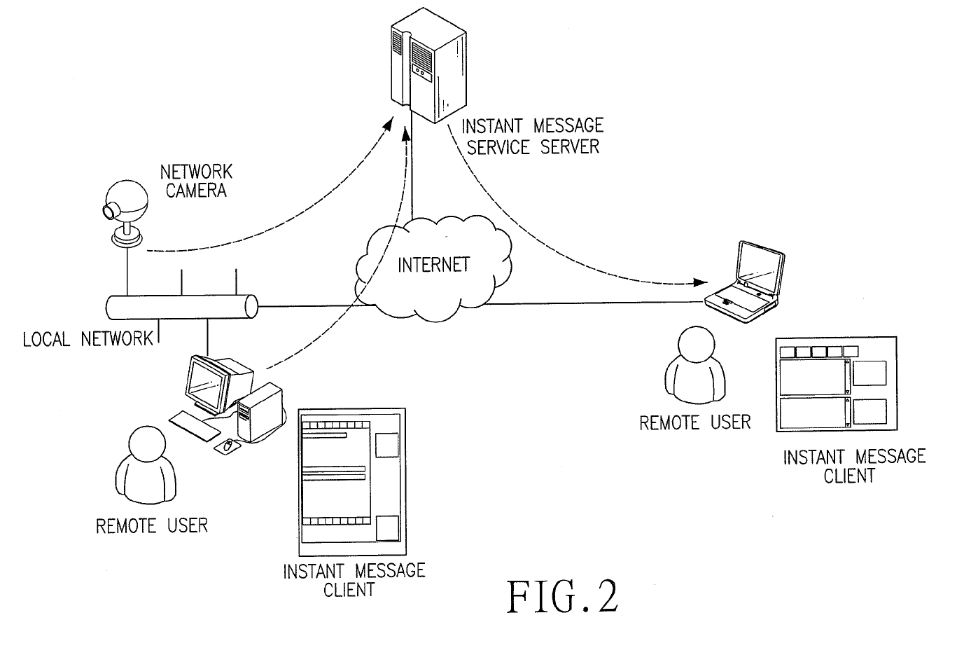

With further reference to FIG. 2, the network connecting module (60) is used to connect to an instant messaging service server (91) over the Internet, is electronically connected to the processor (10) and may comprise a physical wire connecting unit (61), a wireless connecting unit (62) or the combination therein. The physical wire connecting unit (61) connects to the Internet with a wire and may be a network interface card. The wireless connecting unit (62) connects to the Internet under wireless fidelity (Wi-Fi) protocol.

The motion sensor (70) is electronically connected to the processor (10), detects movement and is conventional.

The memory (80) is electronically connected to the processor (10), stores the registered instant messaging user accounts of the network camera and the client device and the password of the network camera and has an automatic operating process, an optional warning process and an optional control process.

The automatic operating process is stored in the memory (80) and is executed by the processor (10) to log on to an instant messaging service, receive viewing requests sent from the client device (92) and send the encoded digital image and sound data to the client device (92).

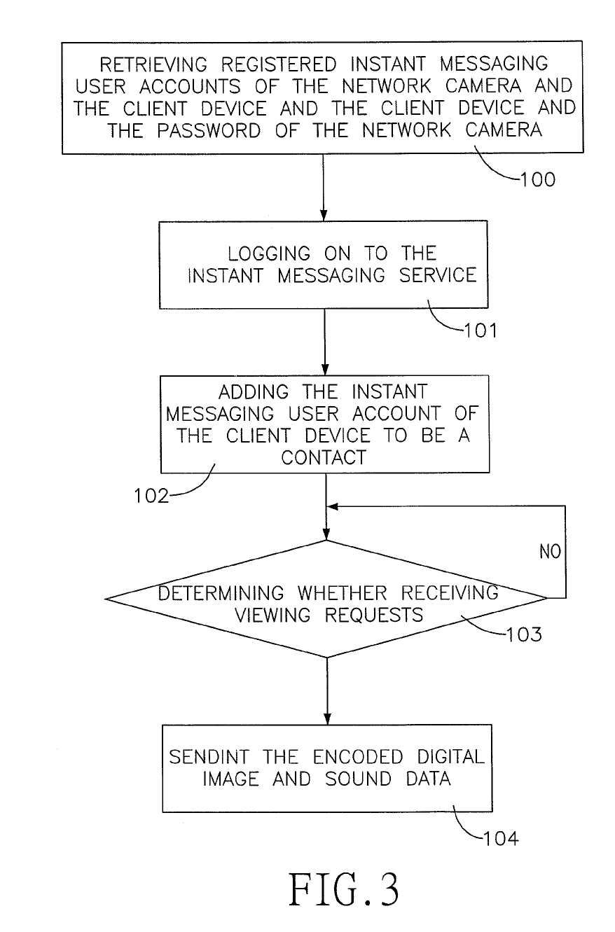

With further reference to FIG. 3, the automatic operating process may comprise steps of retrieving registered instant messaging user accounts of the network camera and the client device and the password of the network camera (100), logging on to the instant messaging service (101), adding the instant messaging user account of the client device to be a contact (102), determining whether receiving viewing requests (103) and sending the encoded digital image and sound data (104).

The step of retrieving registered instant messaging user accounts of the network camera and the client device and the client device and the password of the network camera (100) comprises retrieving registered instant messaging user accounts of the network camera and the client device (92) and the password of the network camera, which were inputted during the initial setup, from the memory (80).

The step of logging on to the instant messaging service (101) comprises the automatic operating process using the registered instant messaging user account of the network camera from the step of retrieving registered instant messaging user accounts of the network camera and client device and the password of the network camera (100) to log on to the instant messaging service.

The step of adding the registered instant messaging user account of the client device to be a contact (102) comprises using the registered instant messaging user account of the client device (92) from the step of retrieving registered instant messaging user accounts of the network camera and client device and the password of the network camera (100) and adding this registered instant messaging user account to an instant messaging contact list, since each instant messaging service allows each user to set their contact lists. Therefore, when the network camera and the client computer both connect to the instant messaging service server (91) and work on-line, the registered instant messaging user account of the network camera will show as a contact on the client computer.

The step of determining whether receiving viewing requests (103) comprises determining whether the network camera receiving a video conferencing request from the client device (92) over the instant messaging service and accepting this request.

If yes, the step of sending the encoded digital image and sound data (104) is performed to send the encoded digital image and sound data to the client device (92), which is just like a live video and audio monitoring.

If no, repeating the step of determining whether receiving viewing requests (103).

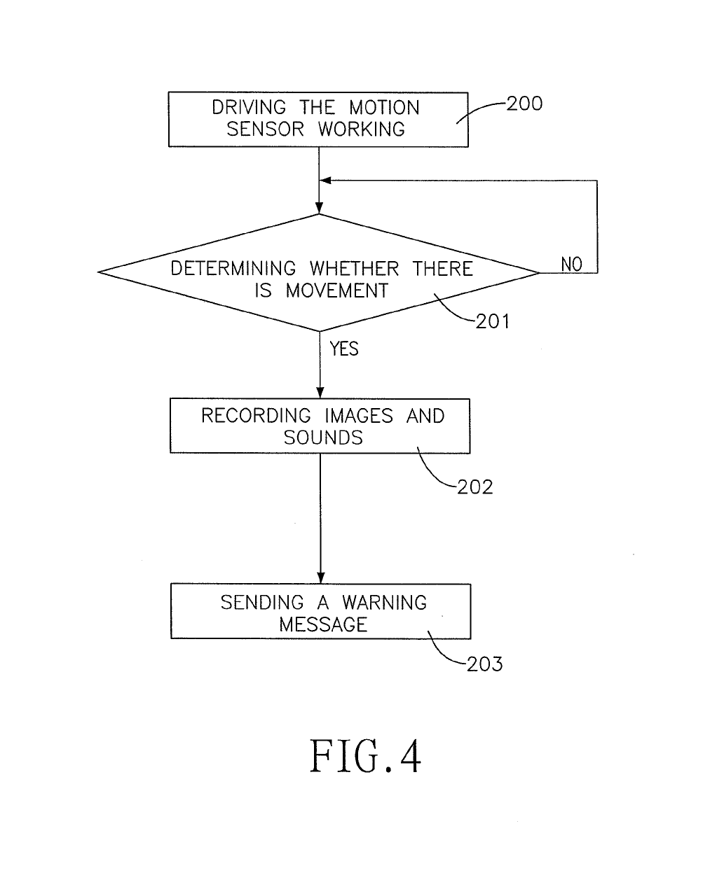

The warning process is stored in the memory (80) and is executed by the processor (10) to send a warning message to the client device (92) when the motion sensor (70) detects movement. With further reference to FIG. 4, the warning process may comprise steps of driving the motion sensor working (200), determining whether there is movement (201), recording images and sounds (202) and sending a warning message (203).

The step of driving the motion sensor working (200) drives the motion sensor (70) to start detecting movement.

The step of determining whether there is movement (201) determines whether the motion sensor (70) detects that something is moving.

If no, the step of determining whether there is movement (201) is repeated.

If yes, the step of recording images and sounds (202) is performed to record images and sounds, convert the images and sounds into digital image and sound data, encode the digital image and sound data and store the encoded digital image and sound data in the storage medium (40).

The step of sending a warning message (203) sends a warning message in an instant message form to the client device (92).

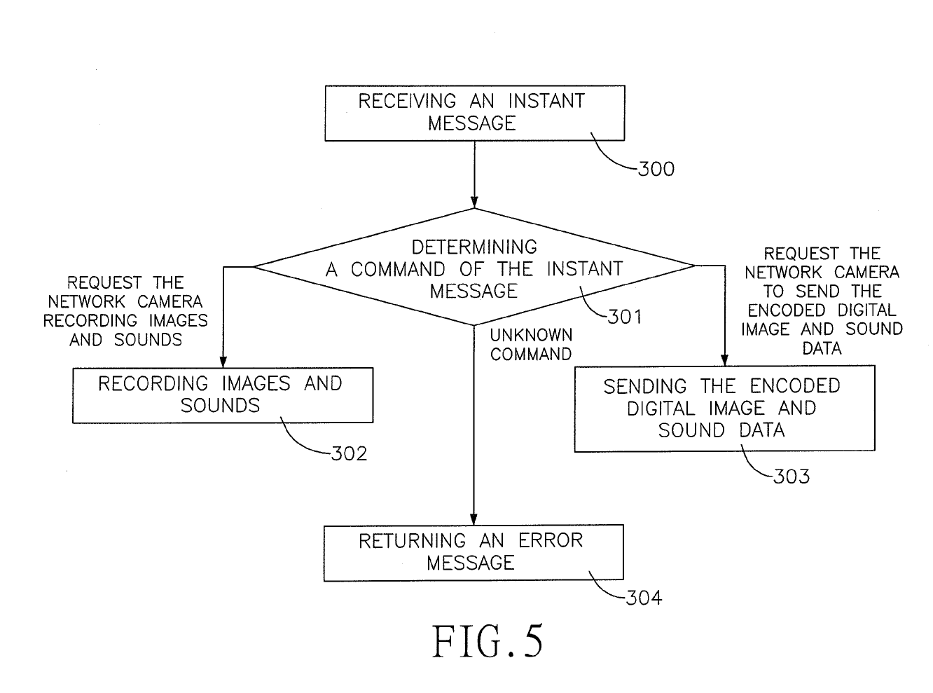

The control process is stored in the memory (80) and is executed by the processor (10) to allow the client device (92) to send a command in the instant message form to control the network camera, and the command may include, but are not limited to, starting recording sounds and images, sending the encoded digital image and sound data stored in the storage medium (40) to the client device (92) or the like. With further reference to FIG. 5, the control process may comprise steps of receiving an instant message (300), determining a command of the instant message (301), recording images and sounds (302), optionally sending the encoded digital image and sound data (303) and optionally returning an error message (304).

The step of receiving an instant message (300) comprises receiving an instant message having a command from the client device (92).

The step of determining a command of the instant message (301) comprises determining the command of the instant message.

If the command is to request the network camera records images and sounds, the step of recording images and sounds (302) is performed to record images and sounds, convert the images and sounds into digital image and sound data, encode the digital image and sound data and store the encoded digital image and sound data in the storage medium (40).

If the command is to request the network camera to send the encoded digital image and sound data, the step of sending the encoded digital image and sound data (303) is performed and the encoded digital image and sound data stored in the storage medium (40) are sent to the client device (92).

If the command is an unknown command, the step of returning the error message (304) is performed, wherein the error message is sent to the client device (92).

Such a network camera does not need a static IP address and is capable of automatically logging on to the instant messaging service. Therefore, the user can control the network camera easily using the instant messaging service and save money on renting the static IP address service from an Internet services provider. Additionally, multiple cameras can be set up to communicate with the same client device (92) that has multiple contacts, so the user can interact with multiple network cameras by logging on to just one instant messaging service, which is more convenient that browsing for multiple static or dynamic IP addresses and is frequently performed on start-up. In addition, the network camera can be easily set up because the user is only required to perform a simple initial setup to input a registered instant messaging user account and a password of the network camera and at least one registered instant messaging user account of a client device. Furthermore, most Internet users are familiar with instant messaging services and need not learn to use other systems, so the present invention facilitates users and allows more people to benefit from increased security provided by network cameras. Besides, the encoded digital image and sound data sent from the network camera would not be blocked by a Network Address Translation (NAT) router because the instant messaging services are capable of allowing the network camera to send the video and audio data through the NAT router.

Even though numerous characteristics and advantages of the present invention have been set forth in the foregoing description, together with details of the structure and function of the invention, the disclosure is illustrative only. Changes may be made in detail, especially in matter of arrangement of parts within the principles of the invention to the full extent indicated by the broad general meaning of the terms in which the appended claims are expressed.

What is claimed is:

1. An instant messaging network camera comprising
a processor having a video encoder and an audio encoder;
an image sensor being electronically connected to the processor, capturing images and converting captured images into digital image data to allow the video encoder in the processor to encode the digital image data;
an audio receiver comprising
a microphone converting sounds into analog signals; and
an analog to digital unit electronically connected between the processor and the microphone to convert the analog signals into digital sound data to allow the audio encoder in the processor to encode the digital sound data;
an input device being electronically connected to the processor to input a registered instant messaging user account and a password of the network camera and a registered instant messaging user account of a client device for logging on to the instant messaging service;
a network connecting module being used to connect to an instant messaging service server over the Internet and being electronically connected to the processor; and
memory being electronically connected to the processor, storing the registered instant messaging user accounts of the network camera and the client device and the password of the network camera and having
an automatic operating process being stored in the memory and executed by the processor to log on to an instant messaging service, receive viewing requests sent from a client device being logged on to the instant messaging service, receiving viewing requests sent from the client device and sending the encoded digital image and sound data to the client device.

2. The instant messaging network camera as claimed in claim 1, wherein the automatic operating process comprises steps of
retrieving registered instant messaging user accounts of the network camera and the client device and the password of the network camera retrieving registered instant messaging user accounts and the password from the memory;
logging on to the instant messaging service comprising using the registered instant messaging user account of the network camera from the step of retrieving registered instant messaging user accounts of the network camera and the client device and the password of the network camera;
adding the registered instant messaging user account of the client device to be a contact comprising using the registered instant messaging user account of the client device from the step of retrieving registered instant messaging user accounts of the network camera and the client device and the password of the network camera and adding this registered instant messaging user account to an instant messaging service contact list;
determining whether receiving viewing requests comprising determining whether the network camera receiving a video conferencing request from the client device and accepting this request; and
sending the encoded digital image and sound data when receiving the video conferencing request from the client device.

3. The instant messaging network camera as claimed in claim 1, wherein the memory further has a control process being stored in the memory and executed by the processor to allow the client device to send a command in an instant message form to control the network camera.

4. The instant messaging network camera as claimed in claim 3 further comprising a storage medium that is electronically connected to the processor to store the encoded digital image and sound data.

5. The instant messaging network camera as claimed in claim 4, wherein the control process comprises steps of
receiving an instant message having a command from the client device;
determining the command of the instant message; and
recording images and sounds to record images and sounds, convert the images and sounds into digital image and sound data, encode the digital image and sound data and store the encoded digital image and sound data in the storage medium when the command is to request the network camera recording images and sounds.

6. The instant messaging network camera as claimed in claim 5, wherein the control process further comprises a step of sending the encoded digital image and sound data stored in the storage medium to the client device when the command is to request the network camera to send the encoded digital image and sound data; and

7. The instant messaging network camera as claimed in claim 5, wherein the control process further comprises a step of returning an error message to the client device when the command is an unknown command.

8. The instant messaging network camera as claimed in claim 1 further comprising a motion sensor, wherein
the motion sensor is electronically connected to the processor and detects movement; and
the memory further has a warning process stored in the memory and executed by the processor to send a warning message to the client device when the motion sensor detects movement.

9. The instant messaging network camera as claimed in claim 8, wherein the warning process comprises steps of
determining whether there is movement;
recording images and sounds to record images and sounds, convert the images and sounds into digital image and sound data, encode the digital image and sound data and store the encoded digital image and sound data in the storage medium if the motion sensor detects movement; and
sending a warning message in an instant message form to the client device.

10. The instant messaging network camera as claimed in claim 1, wherein the network connecting module is a physical wire connecting unit.

11. The instant messaging network camera as claimed in claim 1, wherein the network connecting module is a wireless connecting unit.

12. The instant messaging network camera as claimed in claim 1, wherein the network connecting module comprises a physical wire connecting unit and a wireless connecting unit.
